(19) United States
(12) Patent Application Publication
(10) Pub. No.: US 2026/0097537 A1
(43) Pub. Date: Apr. 9, 2026

(54) SUPPORT DEVICE FOR A BLADE, CUTTING OR PERFORATING DEVICE COMPRISING THE SUPPORT DEVICE, AND MACHINE

(71) Applicant: Valmet Tissue Converting S.p.A., Lucca (IT)

(72) Inventors: Roberto MORELLI, S. Maria a Colle (IT); Matteo GALOPPINI, Lucca (IT)

(73) Assignee: Valmet Tissue Converting S.p.A., Lucca, LU (IT)

(21) Appl. No.: 18/869,385

(22) PCT Filed: May 31, 2023
(86) PCT No.: PCT/EP2023/064593

§ 371 Date: Nov. 26, 2024

(30) Foreign Application Priority Data
May 31, 2022 (IT) 102022000011492

(51) Int. Cl. B26D 7/26; B26D 1/38; B26F 1/20

(52) U.S. Cl. CPC B26D 7/2614; B26D 1/385; B26F 1/20

(57) ABSTRACT

The device includes a support extending in a longitudinal direction. On the support there is provided a seat for a blade, extending in the longitudinal direction of the support. The device further includes at least one locking clamp having a main body and longitudinal edge projecting from the main body above the blade seat. The device further includes thrust members adapted to push the locking clamp against the blade and a movement device, adapted to command a movement of the locking clamp with respect to the support. Shifting the locking clamp it can also be positioned alternatively: in a first position, in which the longitudinal edge of the locking clamp is distanced from the blade, and in a second position, in which the locking clamp is pressed against the blade.

### TECHNICAL FIELD

The present invention relates to machines and devices for converting web materials, for example (but not only) webs of cellulose material such as paper, tissue paper, plies of nonwoven, plastic films and the like.

### BACKGROUND ART

In several industrial fields it is necessary to make cuts or perforations on web materials that are fed continuously along a feed path. For example, in the field of tissue paper converting, to produce rolls of toilet tissue, kitchen towel and similar products, it is necessary to make perforation lines on a web of single-or multi-ply paper fed continuously toward a rewinder. To produce cellulose articles in sheets, it is necessary to cut a continuous web material into single sheets that are then fed to a converting machine, such as an interfolder.

Cuts and perforations are made with specific devices, which have a rotating support device, on which there are arranged one or more cutting or perforating blades, cooperating with a stationary blade (generally also called “counter-blade”), usually supported on a stationary, i.e., non-rotating, support device.

U.S. Pat. No. 5,125,302 illustrates a perforator for rewinders, wherein a plurality of rectilinear blades are carried by a rotating roller or blade-holder, and cooperate with a helical stationary blade (counter-blade).

Some machines for converting paper, in particular tissue paper, are provided with blade devices for cutting a web material into single sheets, separate from one another, instead of joined along perforation and tear lines. For example, cutting devices with rotating blades and stationary counter-blade are used in interfolding machines for producing packs of interfolded sheets. In some embodiments of these machines, the cut is made with a rotating blade-holder that supports a plurality of blades with a constant pitch, which cooperate with a stationary counter-blade. Cutting assemblies of this type, in the context of interfolding machines, are disclosed in EP2379435B1 and EP2502738B1, for instance.

Cutting devices like those of the paper converting field, but of smaller size, are also used in the packaging sector, in particular for machines that package products produced by paper converting lines. These packaging devices wrap a group of products using a wrapping sheet obtained from a continuous paper or plastic web, unwound from a reel. This continuous web requires to be cut crosswise into single sheets. Cutting assemblies are used for this purpose. These are formed by a rotating blade-holder that supports one or more blades, cooperating with a stationary blade or counter-blade carried by a stationary support device. The blades of the rotating blade-holder, which cooperate with the stationary counter-blade, can perform a scissors cut, i.e., in which the contact point between blade and counter-blade moves from one end to the other end of the cutting edges of the blades and of the counter-blade. For this purpose, the rotating blades or the counter-blade have a helical extension. A cutting assembly for packaging machines is disclosed in EP1052209, for instance.

The continuous interaction between rotating blades and stationary blades (counter-blades) causes wear and can also lead to breakage of the blades. Therefore, it is necessary to provide systems that allow the stationary and moving blades to be assembled safely, but also to be easily disassembled for their replacement or adjustment in order to make up for wear.

Various systems for assembling and locking stationary or rotating blades in cutting or perforating devices are known. However, there is still the need to further improve these systems to make locking and release of the blades faster and safer, in order to facilitate the operator, and to simplify maintenance and replacement operations, reducing the machine downtimes required for these operations.

### SUMMARY OF THE INVENTION

According to one aspect, disclosed herein is a support device for a cutting or perforating blade for a web material, that fully or partly overcomes the drawbacks of the prior art. The device comprises a support extending in a longitudinal direction. On the support there is provided is a blade seat, extending in the longitudinal direction of the support. The blade can be rectilinear or helical, for example. The device further comprises at least one locking clamp connected to the support. The locking clamp in turn comprises a main body and a longitudinal edge projecting from the main body above the blade seat. The longitudinal edge has a surface facing the blade seat, to form a space in which to lock the cutting or perforating blade. The device further comprises thrust members adapted to push the locking clamp against the blade and a movement device, adapted to command a movement of the locking clamp with respect to the support. The locking clamp can slide on the support in a direction transversal to the longitudinal edge of the locking clamp upon the command of the movement device. In this movement the locking clamp performs a displacement having a component parallel to the blade seat. By shifting the locking clamp it can be positioned alternatively:
in a first position, in which the longitudinal edge of the locking clamp is distanced from a blade housed in the blade seat, and
in a second position, in which the locking clamp is pressed against the blade housed in the blade seat.

The movement of the locking clamp can be controlled by an actuator or by a manual device, for example an eccentric system.

In practice, the movement of the locking clamp can be a translation and rotation movement, in which the rotation moves the edge of the clamp toward and away from a blade placed on its seat, so as to lock or, selectively, release the blade and allow replacement thereof.

The device allows much faster blade replacement operations compared to the current systems in which screws clamping the blade on its support must be screwed/unscrewed.

Further advantageous features of embodiments of the device outlined above are described hereunder and defined in the appended claims.

According to a further aspect, disclosed herein is a cutting or perforating device comprising a rotating support device for at least one rotating blade and a stationary support device for a stationary blade cooperating with the rotating blade. Characteristically, at least one of said rotating support device and said stationary device is a support device as defined above.

Advantageously, the stationary blade and the rotating blade are positioned so as to perform a scissors cut. For this purpose, one of said stationary blade and said rotating blade has a helical shape and the other preferably has a rectilinear shape, to perform a scissors cut.

According to yet another aspect, disclosed herein is a machine for converting a continuous web material, comprising a feed path of the web material and a cutting or perforating device as defined above.

### BRIEF DESCRIPTION OF THE DRAWINGS

The invention will be better understood by following the description and the accompanying drawings, which illustrate a non-limiting example of embodiment of the invention. More in particular, in the drawing:

FIG. 1 shows a diagram of a rewinder machine with a perforator assembly;

FIG. 2 shows a diagram of an interfolder machine with two cutting assemblies;

FIG. 3 shows a plan view of a locking clamp and related blade;

FIGS. 4A and 4B show cross sections of the support device of the blade and of the locking clamp along the line IV-IV of FIG. 3, in two positions of the locking clamp;

FIG. 5 shows a cross section along V-V of FIG. 3; and

FIGS. 6A and 6B show sections similar to FIGS. 4A, 4B in a further embodiment.

### DETAILED DESCRIPTION

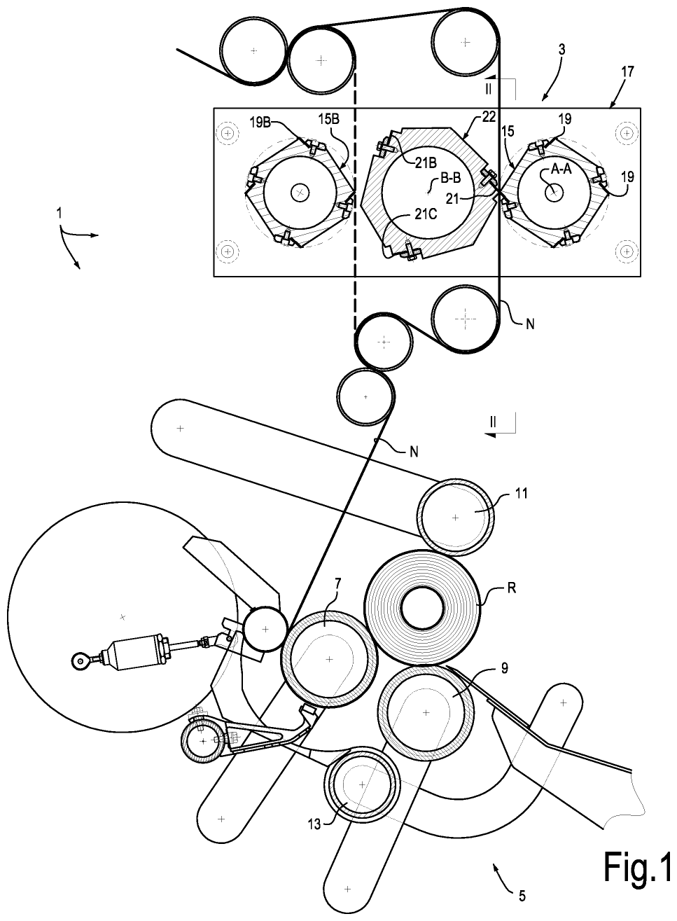

FIG. 1 schematically represents a rewinder 1, provided with a perforator assembly 3. The rewinder 1 is shown as an example of a generic machine for processing or converting a continuous web material N. The structure of the rewinder 1 is illustrated purely by way of example and can vary as known to those skilled in the art.

In general, the rewinder 1 can be a peripheral rewinder, preferably an automatic and continuous peripheral rewinder, i.e., capable of producing automatically, and without stopping, rolls R of wound web material N in rapid sequence.

The rewinder 1 can comprise a winding head 5 provided with a plurality of motorized winding rollers 7, 9, 11, 13 and of other members known to those skilled in the art. Embodiments of rewinding machines are disclosed, in EP2621844, EP0694020 and EP2655227, for instance. In other embodiments, not shown, the rewinder can be a central rewinder, i.e., in which the winding motion is imparted to the logs from the center of a winding spindle or core. In yet other embodiments, the rewinder machine can be a combined peripheral and central rewinder machine, in which the winding motion is transmitted partly by friction through contact between the outer surface of the roll being formed and peripheral winding members (such as rollers or belts) and partly through a pair of tailstocks or other members that engage the roll axially.

Although in the present context the perforator assembly 3 is described in combination with a rewinder 1, which produces rolls of wound material, in other embodiments the perforator assembly 3 can be combined with one or more web material converting machines to produce different articles. For example, the perforator assembly 3 can be combined to a machine for producing packs formed by a continuous web material perforated and folded in a zig-zag fashion.

The perforator assembly 3 comprises a rotating support device for a plurality of rotating blades. Hereinafter, the rotating support device will be indicated as rotating “blade-holder” and is labelled 15. The rotating blade-holder 15 is supported on a load-bearing structure 17, for example comprising two opposite side panels between which the blade-holder 15 is positioned. The blade-holder 15 rotates around a rotation axis A-A. The blade-holder 15 is provided with a set of perforating blades. In general terms, the set of perforating blades can also comprise a single perforating blade. In preferred embodiments, the blade-holder 15 is provided with a plurality of perforating blades. In the illustrated example, the blade-holder 15 is provided with four perforating blades 19, preferably arranged distanced from one another by the same angular pitch around the rotation axis A-A of the rotating blade-holder 15, although it is possible to have a blade-holder provided with a greater number of blades, for example six or eight blades.

In the illustrated embodiment, the perforator assembly 3 comprises a second rotating blade-holder 15B, provided with a second set of rotating blades 19B. The two rotating blade-holders 15, 15B can be used alternatively, optionally according to the type of product to be produced, by feeding the web material N to be perforated along one or other of two alternative paths, indicated in FIG. 1 with a solid and with a dashed line, respectively.

The perforator assembly 3 further comprises a stationary blade, hereinafter indicated as “counter-blade” 21 carried by the support structure 17 and extending, similarly to the blade-holder 15, between the two side panels 17A, 17B and supported thereby. The counter-blade 21 is preferably stationary with respect to the support structure 17. As understood herein, the term “stationary” means that the counter-blade does not participate in the rotation motion that generates the perforation of the web material N. This does not exclude the counter-blade from having any movement. For example, the counter-blade 21 can have a reciprocating translating movement parallel to its longitudinal extension, so as to prevent wear from being concentrated due to the toothed shape of the perforating blades 19. The counter-blade 21 can have a translation and/or rotation movement in order to perform a regulation or adjustment, and/or to select one or other of several counter-blades present in the perforating device 3, as better described below.

To generate perforation lines, rather than a complete cut of the web material, the perforating blades 19, or the counter-blade 21 have a toothed, i.e., discontinuous, cutting edge, with notches at which the web material remains intact, i.e., is not cut, forming points of continuity of the web material.

In the illustrated embodiment, the counter-blade 21 is carried by a stationary, i.e., non-rotating, support device, hereinafter called “beam” and indicated with 22. The beam 22 extends in a direction approximately parallel to the rotation axis A-A of the blade-holder 15. In some embodiments, as illustrated in the accompanying drawing, other additional counter-blades can be provided, indicated with 21B, 21C, for example carried by the same beam 22. The angular position of the latter can be adjusted with a stepped movement around an axis B-B, to selectively bring any one of the counter-blades 21, 21B, 21C into operation.

If the perforator assembly 3 comprises two rotating blade-holders 15, 15B, in this way it is possible to use any one of the counter-blades 21, 21B, 21C alternatively, in combination with the rotating blades 19 or 19B of the blade-holder 15 or of the blade-holder 15B alternatively.

The presence of more than one stationary blade, i.e., perforating counter-blades 21, 21B, 21C can be useful, for example, to rapidly replace a worn counter-blade with another counter-blade. In some embodiments, the counter-blades 21, 21B, 21C can also have features differing from one another, for example toothing different from one another to allow the type of production to be changed, when this change also requires the type of perforation to be changed.

The beam 22 can be mounted on the side panels of the load-bearing structure 17 by means of eccentric supports, so that a small rotation of the beam 22 moves the blade 21, 21B, 21C toward or away, adjusting the interference between the rotating blades 19 and the counter-blade 21, 21B, 21C.

The web material N is fed along a path that extends between the rotating blade-holder 15 and the counter-blade 21, so as to be subjected to the action of the rotating blades 19 and of the counter-blade 21.

To obtain an gradual perforation action across the width of the web material N, the counter-blade 21 can be helical and the blades 19 can be rectilinear, i.e., can be arranged parallel to the rotation axis A-A of the blade-holder 15. The counter-blade 21 is helical in the sense that its cutting edge extends according to a helical line, arranged on an ideal cylindrical surface coaxial to the rotation axis A-A of the blade-holder 15. A perforator assembly 3 with a helical counter-blade and rectilinear rotating perforating blades is disclosed in U.S. Pat. No. 5,125,302.

In other embodiments, the arrangement is reversed, in the sense that the perforating blades 19 are helical, while the counter-blade is rectilinear. In this case the perforating blades 19 are helical in the sense that their cutting edges can extend each along a helical line lying on a cylindrical surface coaxial to the rotation axis A-A of the blade-holder 15.

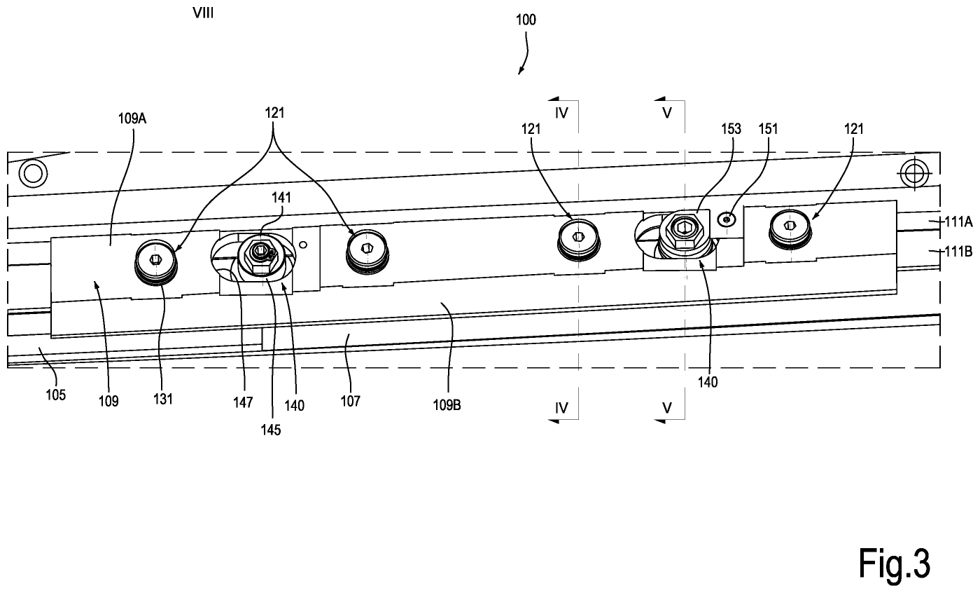

The foregoing description relating to FIG. 1 has the purpose of illustrating the context in which a cutting or perforating device according to the present invention can be used. The details of the device, which can also be used in machines of another type, will be described with reference to the subsequent FIG. 3 a 10.

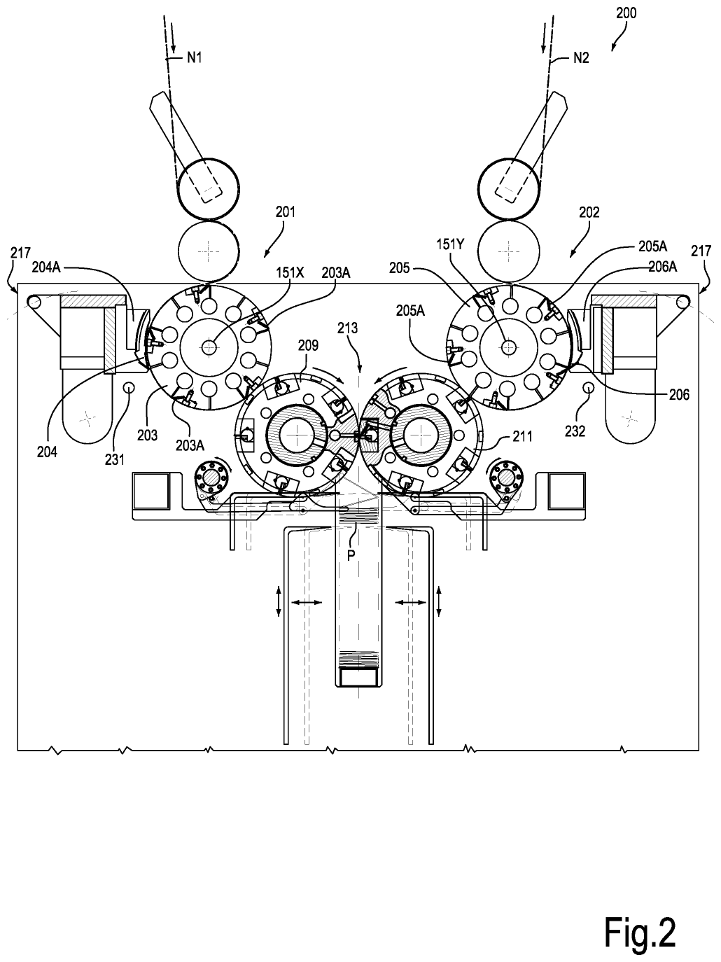

As previously indicated, the device of the present invention can also be used to cut a web material, rather than to perforate it. Before describing in detail embodiments of the cutting or perforating device, with reference to FIG. 2 the structure of cutting devices of an interfolding machine will be briefly described.

With reference to FIG. 2, the interfolding machine 200 comprises a first feed path for a first continuous tissue paper web material N1 and a second feed path for a second continuous tissue paper web material N2. A first cutting assembly or cutting device 201, which comprises a first support device of rotating cutting blades, hereinafter called “rotating cutting roller” 203, is arranged along the first path. The rotating roller 203 is provided with angularly distanced rotating cutting blades 203A. The first rotating cutting roller 203 forms a blade-holder of the cutting assembly 201. The rotating cutting blades 203A cooperate with a first stationary blade 204, hereinafter called “counter-blade”, carried by a stationary, i.e., non-rotating, support device 204A. In the illustrated example, the stationary counter-blade 204 has a helical shape, while the rotating cutting blades 203A have a rectilinear shape, parallel to the rotation axis of the blade-holder or rotating cutting roller 203. However, a reverse arrangement, with a rectilinear stationary counter-blade and helical rotating cutting blades, would also be possible.

A second cutting assembly 202 substantially symmetrical to the first cutting assembly 201 is arranged along the second path. The second cutting assembly 202 comprising a support device of rotating blades, is hereinafter indicated as “rotating cutting roller” 205, which is provided with angularly distanced blades 205A. The rotating cutting roller 205 forms a blade-holder of the cutting assembly 202. The blades 205A cooperate with a stationary, i.e., non-rotating, support device 206A of a second stationary blade, hereinafter called “counter-blade” 206.

In a known manner, the first blade-holder, or rotating cutting roller 203, and the second blade-holder, or rotating cutting roller 205, are provided with suction openings or with other retention means, to hold the sheets obtained by cutting the first and the second continuous web material N1, N2 on the surface of the respective cutting rollers 203, 205 and to transfer said sheets from the cutting rollers 203, 205 to interfolding rollers 209, 211. Said interfolding rollers 209, 211 rotate around respective rotation axes parallel to each other and parallel to the rotation axes of the cutting rollers 203, 205. The two interfolding rollers 209, 211 form an interfolding nip 213. In a known way, the interfolding rollers 209, 211 interfold the sheets coming from the cutting devices 201, 202 to form a stack of sheets P.

Each continuous web material N1, N2 is guided around the respective rotating cutting roller 203, 205 and is fed between the cutting roller, or rotating blade-holder 203, 205, and the stationary counter-blade 204, 206. The cooperation of the rotating cutting blades 203A with the stationary counter-blade 204 cuts the continuous web material N1 into single sheets, which are then transferred from the first cutting roller or rotating blade-holder 203 to the first interfolder roller 209. Similarly, the continuous web material N2 is guided around the second cutting roller, or rotating blade-holder 205, and cut into sheets through cooperation of the rotating cutting blades 205A with the stationary counter-blade 206. The single sheets are then transferred from the second cutting roller or rotating blade-holder 205 to the second interfolding roller 211.

The interfolding machine 200 described briefly above is per se known. Other types of interfolding machines exist, which have only one feed path of a single web material, and which always have at least one cutting assembly.

The foregoing brief description of FIGS. 1 and 2 has the purpose of illustrating by way of non-limiting example some types of machine in which a perforating or cutting device according to the present invention can be inserted. Further examples can be packaging machines for tissue paper products in which cutting or perforating assemblies similar to the foregoing description are usually present. Embodiments of this type of packaging machines are disclosed by way of example in EP1899228, EP2766266 and EP3625132.

FIGS. 3, 4A, 4B and 5 illustrate an embodiment of one of the rotating or stationary support devices of the rotating blades or of the stationary blades (or counter-blades) described with reference to FIGS. 1 and 2. Those skilled in the art will understand that the structure described below and illustrated in FIGS. 3 to 5 can be used both to assemble a rotating blade, and to assemble a stationary blade, or counter-blade. Moreover, this structure can be used both to assemble a rectilinear blade, and to assemble a helical blade. In FIG. 3 a 5 application to a (rotating or stationary) helical blade is illustrated by way of example.

As the support device of FIGS. 3 to 5 can be used in any one of the cutting or perforating devices briefly described above, the components of the device of FIGS. 3 to 5 are indicated with different reference numbers from those used in FIGS. 1 and 2, even when these components are the same or equivalent to those already mentioned with reference to FIGS. 1 and 2.

The support device, indicated as a whole with 100, of FIGS. 3 to 5 comprises a support 103 that can be a stationary beam or a blade-holder or rotating roller. A seat 105 for a blade 107 is provided on the support 103. As mentioned, the blade 107 can be rectilinear and extend according to a longitudinal direction of the support 103. In the embodiment illustrated, the blade 103 is helical, and extends according to a helix with a very long pitch around a longitudinal direction of extension of the support 103.

The seat 105 for the blade 107 extends in the longitudinal direction along the support device 100, in a rectilinear or helical manner, depending upon the shape of the blade 107. In practice, the seat 105 for the blade 107 is formed by a flat surface parallel to the longitudinal direction along which the support 103 extends, in the case of a rectilinear blade. Vice versa, if the blade is helical, the seat 105 for the blade 107 will have the shape of a helically extending ruled surface, i.e., a surface formed by a generatrix consisting of a segment of a straight line, in its movement along a directrix formed by a helical line extending along the longitudinal direction of the support 103.

The support device 100 further comprises one or more locking clamps 109 for the blade 107. In FIGS. 3 to 5 a single locking clamp 109 is shown, but it must be understood that several clamps can be provided aligned along the rectilinear or helical extension of the blade 107, and distributed along the longitudinal extension of the support 103. The locking clamps 109 can be placed close to one another so as to form a substantially continuous locking system along the blade 107. However, this is not strictly essential. The locking clamps 109 can also be distanced from one another preferably with the same pitch.

The locking clamp 109 has a main body 109A and a longitudinal edge 109B protruding from the main body 109A and projecting from the main body 109A above the seat 105 for the blade 107. As will be clarified below, the longitudinal edge 109B is adapted to press the blade 107 against the seat 105 for the blade 107, so as to maintain the blade 107 locked on the support 103.

In addition to the seat 105 for the blade 107, a supporting surface 111 for the locking clamp 109 is also provided on the support 103. More in particular, the supporting surface 111 for the clamp 109 comprises a main supporting surface and an auxiliary supporting surface. In the embodiment of FIG. 3 a 5, the main supporting surface and the auxiliary supporting surface are formed at two different levels. In particular, the main supporting surface is formed by a step 111A and the auxiliary supporting surface is formed by a step 111B, lower than the step 111A. Hereinafter, for brevity, the main supporting surface will be indicated also simply as “step 111A” and the auxiliary supporting surface will be indicated also simply as “step 111B”.

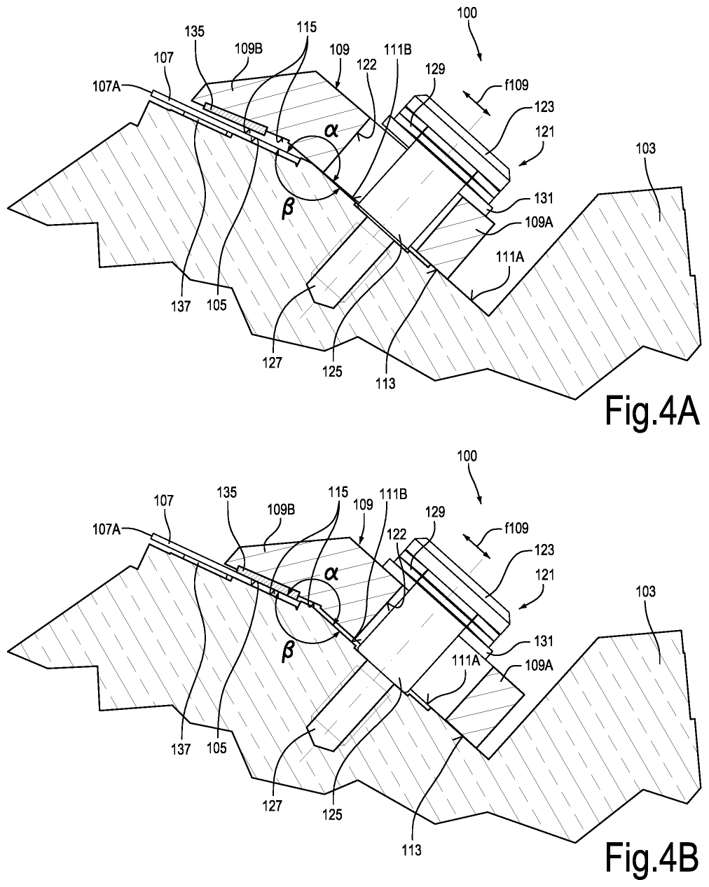

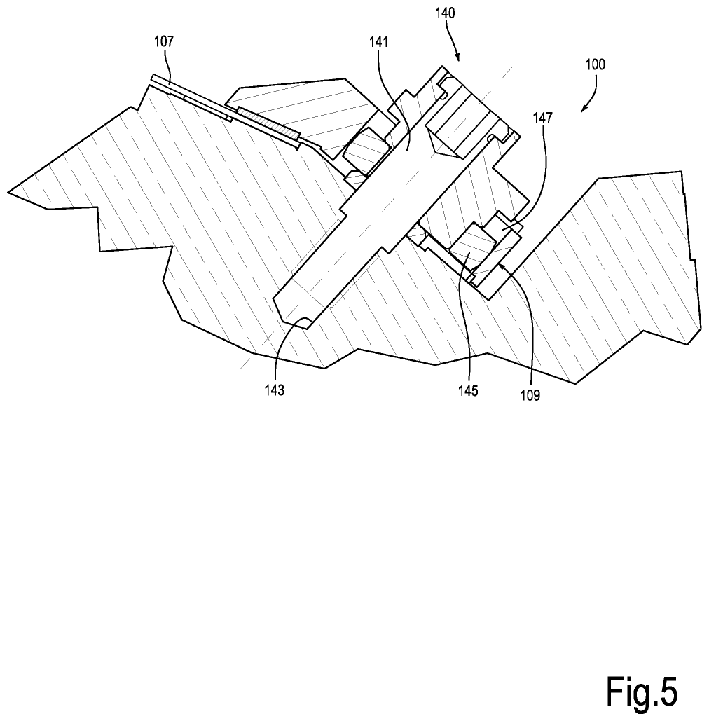

Each main and auxiliary supporting surface formed by the steps 111A, 111B can be formed by a helical groove, i.e., by a helical surface generated by a segment of a straight line that translates along a helical directrix, parallel to the cutting edge of the blade 107, as can be observed in the sections of FIGS. 4A, 4B and 5.

As can be seen in the sectional views, the step 111A is higher than the step 111B, to allow the locking clamp 109 to perform a movement of locking and loosening of the blade 107, as described in more detail below, such movement causing a translation and a rotation of the locking clamp 109.

In a cross section, i.e., in a section according to a plane orthogonal to the longitudinal direction along which the support 103 extends (plane of FIGS. 3, 4A, 4B and 5), the supporting surface 111 for the locking clamp 109 and the seat 105 for the blade 107 form an angle greater than 180°, for example an angle of between 181° and 200°. The angle in question is the angle indicated with a in FIGS. 4A and 4B, i.e., the angle (external to the support 103) formed by the segment of straight line that generates the seat 105 for the blade 107 and by the segment of straight line that generates the auxiliary supporting surface (step 111B).

The body 109A of the clamp 109 has a surface 113 facing the main supporting surface (first step 111A) and the auxiliary supporting surface (second step 111B). Similarly, the longitudinal edge 109B of the locking clamp 109 has a surface 115 facing the seat 105 for the blade 107. The surfaces 113, 115 are complementary respectively to the surface of the steps 111A, 111B and to the surface defining the seat 105 for the blade 107, in the sense that they are formed by helical grooves or by flat surfaces, depending on whether the blade 107 has a helical or rectilinear edge. The surfaces 113 and 115 form an angle β (FIGS. 4A, 4B) of less than 180° between them, for example of between 179° and 160°. The angle in question is the angle indicated with β in FIGS. 4A and 4B, i.e., the angle (external to the locking clamp 109) formed by the segment of straight line that generates the surface 115 and the segment of straight line that generates the surface 113.

In practice, the angles formed respectively by the surfaces 113, 115 and by the surfaces 111, 105 are such that (see FIGS. 4A, 4B), when the body 109A of the locking clamp 109 rests with the surface 113 on the steps 111A, 111B, the surface 115 of the longitudinal edge 109B of the locking clamp 109 is distanced from the blade 107 resting on the surface forming the seat 105 (cf. FIG. 4A). Vice versa, by translating the locking clamp 109 away from the seat 105 of the blade 7 (i.e., translating it from the position of FIG. 4A to the position of FIG. 4B), when the surface 115 of the longitudinal edge 109B comes into contact with the blade 107 arranged in the seat 105, the body 109A of the locking clamp 109 continues to rest with the surface 113 on the step 111A, but moves away from the step 111B (cf. FIG. 4B), and the longitudinal edge 109B presses against the blade 107 positioned in the seat 105.

In the position of FIG. 4B, the blade 107 is held in place by the pressure exerted by the longitudinal edge 109B toward the seat 105, due to the use of elastic members, which will be described in greater detail below.

In practice, as can be understood easily by comparing FIGS. 4A, 4B, the locking clamp 109 moves according to a direction f109, transversal to the longitudinal extension of the blade 107 and of the seat 105 for the blade 107, to take two alternative positions of locking of the blade 107 (FIG. 4B) and of release of the blade 107 (FIG. 4A). The movement is controlled by a movement device described hereunder. In practical embodiments, the movement device comprises an eccentric system.

In both positions of FIGS. 4A, 4B, the locking clamp 109 is pushed against the support 103 by a plurality of thrust members, which in the illustrated embodiment are formed by elastic members.

More in particular, in the illustrated embodiment, pins 121 are provided for this purpose, each comprising a head 123 and a threaded stem 125, screwed into a respective threaded hole 127 of the support 103. The pins 121 extend through through-holes 122 of the body 109A of the locking clamp 109.

Each locking clamp 109 is associated with four pins 121 (see in particular FIG. 3), but the number of pins 121 can be different than the number illustrated, for example depending upon the length of the clamp 109.

Elastic members, such as pairs of Belleville springs 129, are positioned between each head 123 of each pin 121 and the locking clamp 109. In the illustrated embodiment, two superimposed Belleville springs are provided for each pin 121. Between the Belleville springs 129 and the upper surface of the locking clamp 109 washers or other sliding members 131 are provided, preferably made of a material with a low coefficient of friction, which facilitate relative sliding between the springs 129 and the locking clamp 109.

As mentioned above, in FIG. 4A the longitudinal edge 109B of the locking clamp 109 is lifted from the blade 107 and this can be removed from or inserted into the space formed between the seat 105 for the blade 107 and the surface 115 of the longitudinal edge 109B of the locking clamp 109 facing the seat 105. In this position, the locking clamp 109 is pressed by the Belleville springs 129, or other suitable elastic members, against the main supporting surface (first step 111A) and the auxiliary supporting surface (second step 111B) of the supporting surface 111 for the locking clamp 109. The position of the locking clamp 109 is moved forward sufficiently, with respect to the seat 105 for the blade, to allow the surface 115 of the longitudinal edge 109B to be distanced from the blade 107 so as to allow its removal and insertion, for example when a worn or broken blade requires to be adjusted or replaced. In practice, when the locking clamp 109 is shifted to the position of FIG. 4A toward the cutting edge 107A of the blade 107, the locking clamp 109 rests on the auxiliary supporting surface formed by the step 111B, as well as on the main supporting surface 111A, due to the inclinations of the surfaces 113, 115 of the locking clamp 109 and of the auxiliary supporting surface 111B, releasing the blade 107 as a result of the movement of the longitudinal edge 109B away from the blade 107.

The difference in height of the steps 111A, 111B, i.e., the distance between the main supporting surface 111A and the auxiliary supporting surface 111B causes the locking clamp 109 to rotate slightly during the displacement thereof according to the arrow f109 from the position of FIG. 4B to the position of FIG. 4A, thus unloading the Belleville springs 129 and reducing the force required to move the locking clamp 109.

In the opposite movement, from the position of FIG. 4A to the position of FIG. 4B, the locking clamp 109 rotates in the opposite direction, pushed by the reaction between the surface 115 of the longitudinal edge 109B and the blade 107, thereby carrying (FIG. 4B) the longitudinal edge 109B to press against the blade 107 and at the same time moving the surface 115 away from the auxiliary supporting surface represented by the step 111B.

In fact, by translating the locking clamp 109 from the position of FIG. 4A to the position of FIG. 4B, i.e., withdrawing the locking clamp 109 with respect to the blade 107 resting on the seat 105, the surface 115 of the longitudinal edge 109B comes into contact with the upper surface of the blade 107. Due to the mutual inclination of the surfaces 115, 113 and 105, 111 (111A, 111B), the translation and withdrawal of the locking clamp 109 causes a rotation of the locking clamp 109 with a lifting of the surface 115 from the step 111B, so that in the position of FIG. 4B the locking clamp 109 is resting on the step 111A and on the blade 107. The elastic members (Belleville springs 129 in the example illustrated) push the locking clamp 109 against the step 113 and against the blade 107, so that the latter is locked in the seat formed by the longitudinal edge 109B of the locking clamp 109 and by the supporting surface 105 for the blade 107.

To obtain a better contact between longitudinal edge 109B of the locking clamp 109 and upper surface of the blade 107, opposite the seat 105 for the blade 107, the longitudinal edge 109B can be provided, on the side facing the blade 107, with an insert 135 made of an elastomeric material, such as natural or synthetic rubber. This elastomeric insert 135 can act as a damper to reduce the transmission of vibrations between the blade 107 and the support 103. Moreover, the elastomeric insert 135 can improve the mutual contact between longitudinal edge 109B and blade 107, compensating for any shape or dimensional defects. The outer surface of the elastomeric insert 135 forms the (or part of the) surface 115 of the longitudinal edge 109B of the locking clamp 109.

A further sheet-shaped damping element 137 can be housed in a lowered zone of the seat 105 for the blade 107, to provide further damping of the mechanical vibrations of the blade 107 during use.

To facilitate the displacement of the locking clamp 109 from one to the other of the two positions illustrated in FIGS. 4A and 4B, in some embodiments a movement device is provided. In some embodiments (not shown) the movement device can comprise an actuator.

In the illustrated embodiment, the movement device comprises an eccentric system. More in particular, in the illustrated embodiment two eccentric members have been provided, identical to each other and both indicated with 140 (cf. FIG. 3). The number of the eccentric members 140 can vary according to the length of the locking clamp 109.

In the illustrated embodiment, each eccentric member 140 comprises (see FIG. 5) a threaded stem 141 engaged in a threaded hole 143 of the support 103. An eccentric 145 engaged in a through slot 147 of the locking clamp 109 is rotatably mounted on the threaded pin 141, said threaded pin 141 extending through the slot. The eccentric has a diameter equal to the smallest transverse dimension of the slot 147. In this way, rotation of the eccentric around the axis of the threaded pin 141 causes a displacement of the locking clamp 109 in the direction f109 from the position of FIG. 4A to the position of FIG. 4B and vice versa. In some embodiments, a system can be provided, for locking each eccentric 145 in the position in which the locking clamp 109 clamps the blade 107 (FIG. 4B). For example, for this purpose, a magnet 151 can be provided, for instance, which cooperates with a ferromagnetic appendage 153 integral with the eccentric 149, as shown schematically regarding the eccentric device 140 on the right in FIG. 3. In this way, it is possible to hold the eccentric 145 still during operation and prevent it from moving, or even only from vibrating due to the vibrations triggered by interaction between blade and counter-blade.

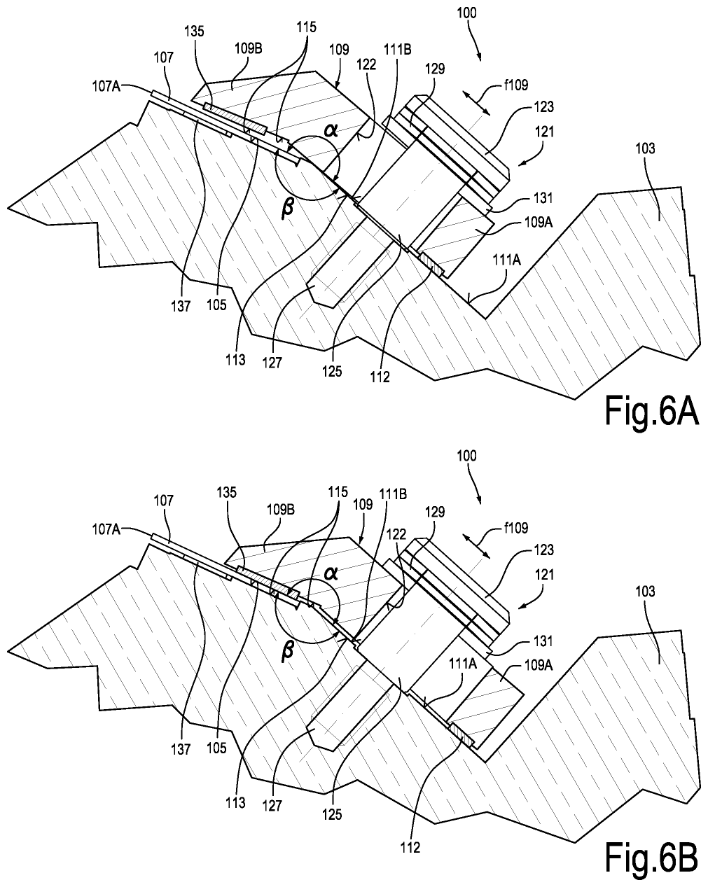

The translation and rotation movement of the locking clamp 109 with respect to the seat 105 for the blade 107 with consequent movement from the clamping position of the blade 107 to the release position of the blade 107 and vice versa, can be obtained with a different form of the main supporting surface 111A and of the auxiliary supporting surface 111B, and of the surface 113 of the main body 109A of the locking clamp 109. This different embodiment is illustrated in FIGS. 6A, 6B, which are the same as FIGS. 4A, 4B and respectively show the position with the blade 107 released and free and the position with the blade 107 clamped on the seat 105 by the locking clamp 109.

In the embodiment of FIGS. 6A, 6B, the main supporting surface 111A and the auxiliary supporting surface 111B are not placed at different heights, but at the same height. In practice, the main supporting surface 111A and the auxiliary supporting surface 111B form each an extension of the other, and together can form a continuous surface, i.e., without steps. The surface can be flat in the case of rectilinear blade 107, or can be a helical ruled surface, in the case of helical blade 107.

To obtain rotation of the locking clamp 109 during the translation movement thereof from the position of FIG. 6A to the position of FIG. 6B and vice versa, the main body of the locking clamp 109 has, on the surface thereof 113 facing the main supporting surface 111A and toward the auxiliary supporting surface 111B, a projection 112, i.e., a protrusion that forms a contact element with the first supporting surface 111A.

As can be understood from FIGS. 6A, 6B, by moving the locking clamp 109 from the position of FIG. 6A to the position of FIG. 6B, the surface 115 of the longitudinal edge 109B facing the seat 105 for the blade 107 moves toward the blade 107 until they are touching, while the main body 109A of the locking clamp slides on the main supporting surface 111A and on the auxiliary supporting surface 111B. When the longitudinal edge 109B of the locking clamp 109 comes into contact with the blade 107, continuation of the translation movement of the locking clamp toward the position of FIG. 6B causes a rotation of the locking clamp 109 around the projection 112 and consequent lifting of the locking clamp 109 from the auxiliary supporting surface 111B.

In the final position of FIG. 6B the force applied by the Belleville springs 129 (or other elastic member) is partly transferred to the main supporting surface 111A and partly to the blade 107, which is held blocked in the seat 105, while there is no interaction between the main body 109A and the auxiliary supporting surface 111B, as occurs also in the embodiment of FIGS. 4A, 4B.

A reverse translation and rotation movement of the locking clamp 109 is obtained by moving the locking clamp from the position of FIG. 6B to the position of FIG. 6A. In this case, the force applied to the blade 107 is transferred gradually, while the locking clamp rests on the auxiliary supporting surface 111B.

With respect to the embodiment of FIGS. 4A, 4B, the embodiment of FIGS. 6A, 6B has the advantage of simplifying machining of the support 103. Moreover, the projection 112 can be easily manufactured in a material different from the material that forms the support 103 and also from the material that forms the rest of the main body 109A of the locking clamp 109. For example, the projection 112 can be an added piece (as shown in the drawing), made of polytetrafluoroethylene, Turcite® or other materials with low coefficient of friction. This reduces the force required to translate the locking clamp and concentrates wear on the insert forming the projection 112, which can be easily replaced.

1-21. (canceled)

22. A support device for a blade for cutting or perforating a web material, said device comprising:
a support extending in a longitudinal direction;
on the support, a seat for a blade, extending in the longitudinal direction of the support;
at least one locking clamp connected to the support, wherein the locking clamp comprises a main body and a longitudinal edge projecting from the main body above the seat for a blade, and wherein the longitudinal edge has a surface facing the seat for a blade;
thrust members adapted to push the locking clamp against the blade;
a movement device, adapted to command a movement of the locking clamp with respect to the support;
wherein the locking clamp can slide on the support in a direction transversal to the longitudinal edge of the locking clamp upon the command of the movement device, to take:
a first position, in which the longitudinal edge of the locking clamp is distanced from a blade housed in the seat for a blade, and
a second position, in which the locking clamp is pressed against a blade housed in the seat for a blade.

23. The support device of claim 22, wherein the support is provided with a main supporting surface and an auxiliary supporting surface, extending in the longitudinal direction; wherein the auxiliary supporting surface is adjacent to the seat for a blade and is arranged between the seat for a blade and the main supporting surface; and wherein the main body of the locking clamp has a surface facing the main supporting surface and the auxiliary supporting surface.

24. The support device of claim 23, wherein the seat for a blade and the auxiliary supporting surface form an angle of 180° between them; wherein the surface of the longitudinal edge facing the seat and the surface of the locking clamp body facing the main supporting surface and the auxiliary supporting surface form an angle of less than 180°.

25. The device of claim 23, wherein the main supporting surface, the auxiliary supporting surface and the surface of the main body of the locking clamp facing the main supporting surface and the auxiliary supporting surface are configured so that, when the locking clamp rests on the main supporting surface:
a sliding movement of the locking clamp from the first position to the second position causes a rotational movement of the locking clamp which brings the longitudinal edge under pressure against a blade located in the seat for a blade, while raising the body of the locking clamp from the auxiliary supporting surface; and
a sliding movement of the locking clamp from the second position to the first position causes a rotational movement of the locking clamp which brings the main body of the locking clamp to rest on the auxiliary supporting surface and the longitudinal edge of the locking clamp to move away from the blade housed in the seat.

26. The device of claim 25, wherein the main supporting surface and the auxiliary supporting surface are formed by a first step and a second step respectively, wherein the second step is lower than the first step.

27. The device of claim 26, wherein the surface of the main body of the locking clamp facing the main supporting surface and the auxiliary supporting surface is a continuous surface.

28. The device of claim 25, wherein the main supporting surface and the auxiliary supporting surface form a continuous supporting surface, and wherein the surface of the main body of the locking clamp facing the main supporting surface and the auxiliary supporting surface has a projection in contact with the main supporting surface.

29. The device of claim 28, wherein the projection is formed by an insert of material with lower resistance to wear and/or friction with respect to the material of which the support is formed, and is interchangeable.

30. The device of claim 22, wherein the longitudinal edge of the locking clamp comprises an elastic element adapted to be pressed against the blade.

31. The device of claim 22, wherein the movement device comprises at least one eccentric system for commanding the movement of the locking clamp.

32. The device of claim 31, wherein the locking clamp comprises at least one slot passing through a thickness of the main body of the locking clamp; and wherein an eccentric member is engaged in the at least one slot, rotating around an axis transversal to the support, and rotation of the eccentric member causing translation of the locking clamp from the first position to the second position and vice-versa.

33. The device of claim 32, wherein the locking clamp comprises at least a second slot passing through the thickness of the main body of the locking clamp; and wherein a second eccentric member is engaged in the second slot, rotating around a second axis transversal to the support, and rotation of the second eccentric member causing translation of the locking clamp from the first position to the second position and vice-versa.

34. The device of claim 22, wherein the thrust members comprise elastic members.

35. The device of claim 34, wherein the locking clamp comprises a plurality of through-holes, through which respective pins extend with a stem passing through a respective hole and a head; and wherein the elastic members are positioned between the head of each pin and the locking clamp.

36. The device of claim 35, wherein for each pin there is provided a pair of elastic members, said elastic members comprising springs.

37. The device of claim 35, wherein each pin is associated with a sliding member, placed between the locking clamp and the elastic members.

38. The device of claim 22, wherein the supporting surface for the blade has a lowered zone, and wherein between the lowered zone and the blade a laminar damping element is housed.

39. The device of claim 22, wherein the seat for a blade and the locking clamp are configured to fix to the support a blade having a helical shape along the longitudinal extension of the support.

40. A cutting or perforating device, comprising a rotating support device for at least one rotating blade and a stationary support device for a stationary blade cooperating with the rotating blade, wherein at least one of said rotating support device and said stationary device comprises:
a support extending in a longitudinal direction;
on the support, a seat for a blade, extending in the longitudinal direction of the support;
at least one locking clamp connected to the support, wherein the locking clamp comprises a main body and a longitudinal edge projecting from the main body above the seat for a blade, and wherein the longitudinal edge has a surface facing the seat for a blade;
thrust members adapted to push the locking clamp against the blade;
a movement device, adapted to command a movement of the locking clamp with respect to the support;
wherein the locking clamp can slide on the support in a direction transversal to the longitudinal edge of the locking clamp upon the command of the movement device, to take:
a first position, in which the longitudinal edge of the locking clamp is distanced from a blade housed in the seat for a blade, and
a second position, in which the locking clamp is pressed against the blade housed in the seat for a blade.

41. The cutting or perforating device of claim 40, wherein the stationary blade and the rotating blade are positioned so as to perform a scissors cut, with one of said stationary blade and said rotating blade having a helical shape and the other having a straight shape.

42. A machine for transformation of a continuous web material, comprising
a feed path for the web material and a cutting or perforating device comprising a rotating support device for at least one rotating blade and a stationary support device for a stationary blade cooperating with the rotating blade; wherein at least one of said rotating support device and said stationary device comprises:
a support extending in a longitudinal direction;
on the support, a seat for a blade, extending in the longitudinal direction of the support;
at least one locking clamp connected to the support, wherein the locking clamp comprises a main body and a longitudinal edge projecting from the main body above the seat for a blade, and
wherein the longitudinal edge has a surface facing the seat for a blade;
thrust members adapted to push the locking clamp against the blade;
a movement device, adapted to command a movement of the locking clamp with respect to the support;
wherein the locking clamp can slide on the support in a direction transversal to the longitudinal edge of the locking clamp upon the command of the movement device, to take:
a first position, in which the longitudinal edge of the locking clamp is distanced from a blade housed in the seat for a blade, and
a second position, in which the locking clamp is pressed against the blade housed in the seat for a blade.
